(19) United States
(12) Patent Application Publication
(10) Pub. No.: US 2023/0161681 A1
(43) Pub. Date: May 25, 2023

(54) METHOD AND SYSTEM FOR ENCOURAGING TIME AWAY FROM SOCIAL MEDIA

(71) Applicant: Meta Platforms Technologies, LLC, Menlo Park, CA (US)

(72) Inventors: Li Lin Pearly Tan, Berkeley, CA (US); Dana Nicole Sasinowski, Seattle, WA (US); Danielle Frimer, Highland, NY (US); Gabrielle Catherine Moskey, San Mateo, CA (US)

(21) Appl. No.: 17/977,952

(22) Filed: Oct. 31, 2022

Related U.S. Application Data
(60) Provisional application No. 63/283,169, filed on Nov. 24, 2021.

(51) Int. Cl. G06F 11/34

(52) U.S. Cl. CPC G06F 11/3438; G06Q 50/01

(57) ABSTRACT

Methods, systems, and storage media for using a social media network virtual assistant to encourage alternatives to social media engagement activities are disclosed. Exemplary implementations may: receive, from a user, a first set of instructions regarding at least one of a time and a condition during which one or more alternatives to social media engagement are to be encouraged; determine, via the social media network virtual assistant, the one or more alternatives to social media engagement that are to be encouraged; determine, via the social media network virtual assistant, that the at least one of the time and the condition have been satisfied; and responsive to determining that the at least one of the time and the condition has been satisfied, cause, via the social media network virtual assistant, the one or more alternatives to social media engagement to be communicated to the user.

### CROSS REFERENCE TO RELATED APPLICATIONS

This present application claims the benefit of priority under 35 U.S.C. § 119(e) to U.S. Provisional Application No. 63/283,169, filed Nov. 24, 2021, the disclosure of which is hereby incorporated by reference in its entirety for all purposes.

### TECHNICAL FIELD

The present disclosure generally relates to encouraging time away from social media, and more particularly to using a social media network virtual assistant to encourage alternatives to social media engagement activities.

### BRIEF SUMMARY

The subject disclosure provides for systems and methods for encouraging time away from social media. One aspect of the present disclosure relates to a method for using a social media network virtual assistant to encourage alternatives to social media engagement activities. The method may include receiving, from a user, a first set of instructions regarding at least one of a time and a condition during which one or more alternatives to social media engagement are to be encouraged. The method may include determining, via the social media network virtual assistant, the one or more alternatives to social media engagement that are to be encouraged. The method may include determining, via the social media network virtual assistant, that the at least one of the time and the condition have been satisfied. The method may include, responsive to determining that the at least one of the time and the condition has been satisfied, causing, via the social media network virtual assistant, the one or more alternatives to social media engagement to be communicated to the user.

Another aspect of the present disclosure relates to a system configured for using a social media network virtual assistant to encourage alternatives to social media engagement activities. The system may include one or more hardware processors configured by machine-readable instructions. The processor(s) may be configured to receive, from a user, a first set of instructions regarding at least one of a time and a condition during which one or more alternatives to social media engagement are to be encouraged. The processor(s) may be configured to determine, via the social media network virtual assistant, the one or more alternatives to social media engagement that are to be encouraged. The processor(s) may be configured to determine, via the social media network virtual assistant, that the at least one of the time and the condition have been satisfied. The processor(s) may be configured to, responsive to determining that the at least one of the time and the condition has been satisfied, cause, via the social media network virtual assistant, the one or more alternatives to social media engagement to be communicated to the user.

Yet another aspect of the present disclosure relates to a non-transient computer-readable storage medium having instructions embodied thereon, the instructions being executable by one or more processors to perform a method for using a social media network virtual assistant to encourage alternatives to social media engagement activities. The method may include receiving, from a user, a first set of instructions regarding at least one of a time and a condition during which one or more alternatives to social media engagement are to be encouraged. The method may include determining, via the social media network virtual assistant, the one or more alternatives to social media engagement that are to be encouraged. The method may include determining, via the social media network virtual assistant, that the at least one of the time and the condition have been satisfied. The method may include, responsive to determining that the at least one of the time and the condition has been satisfied, causing, via the social media network virtual assistant, the one or more alternatives to social media engagement to be communicated to the user.

Still another aspect of the present disclosure relates to a system operable to use a social media network virtual assistant to encourage alternatives to social media engagement activities. The system may include means for receiving, from a user, a first set of instructions regarding at least one of a time and a condition during which one or more alternatives to social media engagement are to be encouraged. The system may include means for determining, via the social media network virtual assistant, the one or more alternatives to social media engagement that are to be encouraged. The system may include means for determining, via the social media network virtual assistant, that the at least one of the time and the condition have been satisfied. The system may include means for, responsive to determining that the at least one of the time and the condition has been satisfied, causing, via the social media network virtual assistant, the one or more alternatives to social media engagement to be communicated to the user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system operable to use a social media network virtual assistant to encourage alternatives to social media engagement activities, in accordance with one or more implementations.

FIG. 2 illustrates a method for using a social media network virtual assistant to encourage alternatives to social media engagement activities, in accordance with one or more implementations.

FIG. 3 is a block diagram illustrating an exemplary computing system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

In contemporary times, humans tend to engage with online resources including socialization via handheld mobile devices, which often results in isolated behavior with users staring at their screens and scrolling. Embodiments described herein address these and other shortcomings by facilitating technology engagement with a more present and embodied social life. For example, exemplary implementations may provide an option to “Choose Your Days Off” to encourage social media free days. A digital assistant may provide outdoor suggestions based on user interests (e.g., hiking trails for hikers, meetup groups for specific interests, etc.) on days when a user is not working (e.g., adjustable as not everyone has Saturday and Sunday's off).

Some implementations may include an application do-not-disturb (DND) coupled with the digital assistant to keep track of updates (e.g., may be performed in the background) and aggregate into a digest for a user to catch up on when the user is ready to look back at updates and notifications. The user may specify certain types of updates or from certain people to allow a proactive notification to override the DND state.

In some implementation, a setup assistant may help users tune an algorithm to setup what they see (e.g., in a social media feed). For example, responsive to a user choosing not to see certain information throughout a certain day, that information may be aggregated and made available to the user as a digest. Examples of such a digest may include a digital assistant voice summary, a summary presented via a graphical user interface, and/or other digests. In some implementations, a card may pop up on a digital portal and then read aloud. In some implementations augmented reality (AR) devices (e.g., glasses, goggles, etc.) may be configured to narrate at segmented times throughout a day. Some implementations may determine where a user is walking or traveling and whether the user is available and, upon positive determination, play an audio summary of a social digest, thus reducing the user's screen time. Some implementations may determine “need-to-know” content and “want-to-know” content such that the user does not need to manually filter through want-to-know content for need-to-know content. Some implementations contemplate different habits in life (e.g., brushing teeth, eating breakfast, walking, etc.). Some implementations may change the delivery method of a summary or social digest based on a user's present situation or context. Some implementations may provide a visual hint (e.g., with a “wave”) in a heavy cognitive load atmosphere as a low impact notification (e.g., ask about the notification).

The disclosed system(s) address a problem in traditional social media tied to computer technology, namely, the technical problem of requiring excessive screen time to accomplish a desired amount of digital interactions and/or content consumption. The disclosed system solves this technical problem by providing a solution also rooted in computer technology, namely, by providing for using a social media network virtual assistant to encourage alternatives to social media engagement activities. The disclosed subject technology further provides improvements to the functioning of the computer itself because it improves processing and efficiency in encouraging time away from social media.

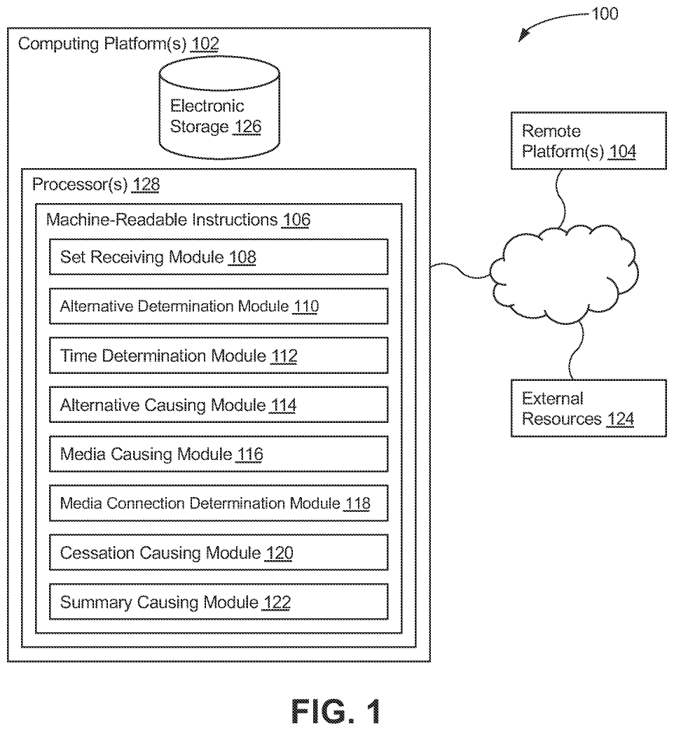

FIG. 1 illustrates a system 100 operable to use a social media network virtual assistant to encourage alternatives to social media engagement activities, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of set receiving module 108, alternative determination module 110, time determination module 112, alternative causing module 114, media causing module 116, media connection determination module 118, cessation causing module 120, summary causing module 122, and/or other instruction modules.

Set receiving module 108 may be configured to receive, from a user, a first set of instructions regarding at least one of a time and a condition during which one or more alternatives to social media engagement are to be encouraged. The first set of instructions may include a directive to implement a do-not-disturb functionality. The first set of instructions may include an override directed to one or more of the social media engagement activities that excepts the one or more of the social media engagement activities from the directive to implement the do-not-disturb functionality.

Alternative determination module 110 may be configured to determine, via the social media network virtual assistant, the one or more alternatives to social media engagement that are to be encouraged.

Time determination module 112 may be configured to determine, via the social media network virtual assistant, that the at least one of the time and the condition have been satisfied. Time determination module 112 may be configured to determine, via the social media network virtual assistant, that the at least one of the time and the condition is no longer satisfied.

Alternative causing module 114 may be configured to, responsive to determining that the at least one of the time and the condition has been satisfied, cause, via the social media network virtual assistant, the one or more alternatives to social media engagement to be communicated to the user. Causing, via the social media network virtual assistant, the one or more alternatives to social media engagement to be communicated to the user may include causing an alternative to social media engagement to be communicated to the user that involves the social media connection of the user.

Media causing module 116 may be configured to, responsive to determining that the at least one of the time and the condition has been satisfied, cause at least a portion of the social media engagement activities to be inoperable.

Media connection determination module 118 may be configured to determine, via the social media network virtual assistant, that a social media connection of the user has a second set of instructions including at least one of a time and a condition during which at least one alternative to social media engagement is to be encouraged that overlaps with the at least one of the time and the condition included in the first set of instructions.

Cessation causing module 120 may be configured to, responsive to determining that the at least one of the time and the condition are no longer satisfied, cause, via the social media network virtual assistant, cessation of communication of the one or more alternatives to social media engagement to the user.

Summary causing module 122 may be configured to, responsive to determining that the at least one of the time and the condition are no longer satisfied, cause a summary to be displayed. The summary may include at least a portion of information missed during a time frame in which the one or more alternatives to social media engagement were encouraged.

In some implementations, computing platform(s) 102, remote platform(s) 104, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 124 may be operatively linked via some other communication media.

A given remote platform 104 may include one or more processors configured to execute computer program modules. The computer program modules may be configured to enable an expert or user associated with the given remote platform 104 to interface with system 100 and/or external resources 124, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 124 may include sources of information outside of system 100, external entities participating with system 100, and/or other resources. In some implementations, some or all of the functionality attributed herein to external resources 124 may be provided by resources included in system 100.

Computing platform(s) 102 may include electronic storage 126, one or more processors 128, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 126 may comprise non-transitory storage media that electronically stores information. The electronic storage media of electronic storage 126 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from computing platform(s) 102, information received from remote platform(s) 104, and/or other information that enables computing platform(s) 102 to function as described herein.

Processor(s) 128 may be configured to provide information processing capabilities in computing platform(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some implementations, processor(s) 128 may include a plurality of processing units. These processing units may be physically located within the same device, or processor(s) 128 may represent processing functionality of a plurality of devices operating in coordination. Processor(s) 128 may be configured to execute modules 108, 110, 112, 114, 116, 118, 120, and/or 122, and/or other modules. Processor(s) 128 may be configured to execute modules 108, 110, 112, 114, 116, 118, 120, and/or 122, and/or other modules by software; hardware; firmware; some combination of software, hardware, and/or firmware; and/or other mechanisms for configuring processing capabilities on processor(s) 128. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, and/or 122 are illustrated in FIG. 1 as being implemented within a single processing unit, in implementations in which processor(s) 128 includes multiple processing units, one or more of modules 108, 110, 112, 114, 116, 118, 120, and/or 122 may be implemented remotely from the other modules. The description of the functionality provided by the different modules 108, 110, 112, 114, 116, 118, 120, and/or 122 described below is for illustrative purposes, and is not intended to be limiting, as any of modules 108, 110, 112, 114, 116, 118, 120, and/or 122 may provide more or less functionality than is described. For example, one or more of modules 108, 110, 112, 114, 116, 118, 120, and/or 122 may be eliminated, and some or all of its functionality may be provided by other ones of modules 108, 110, 112, 114, 116, 118, 120, and/or 122. As another example, processor(s) 128 may be configured to execute one or more additional modules that may perform some or all of the functionality attributed below to one of modules 108, 110, 112, 114, 116, 118, 120, and/or 122.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

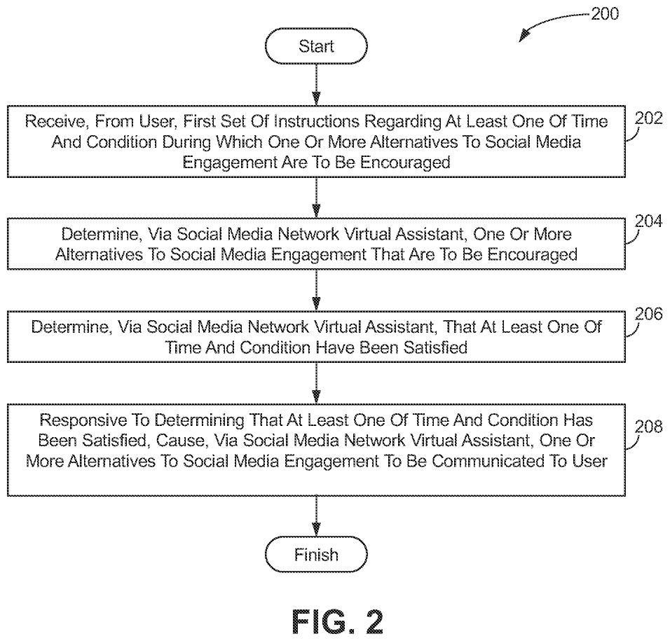

FIG. 2 illustrates an exemplary flow diagram (e.g., process 200) for encouraging time away from social media, according to certain aspects of the disclosure. For purposes of explanation of the subject technology, the exemplary process 200 is described herein with reference to FIG. 1. Further for explanatory purposes, the steps of the exemplary process 200 are described herein as occurring in serial, or linearly. However, multiple instances of the example process 200 may occur in parallel.

At step 202, the process 200 may include receiving, from a user, a first set of instructions regarding at least one of a time and a condition during which one or more alternatives to social media engagement are to be encouraged. At step 204, the process 200 may include determining, via the social media network virtual assistant, the one or more alternatives to social media engagement that are to be encouraged. At step 206, the process 200 may include determining, via the social media network virtual assistant, that the at least one of the time and the condition have been satisfied. At step 208, the process 200 may include responsive to determining that the at least one of the time and the condition has been satisfied, causing, via the social media network virtual assistant, the one or more alternatives to social media engagement to be communicated to the user.

For example, as described above in relation to FIG. 1, at step 202, the process 200 may include receiving, from a user, a first set of instructions regarding at least one of a time and a condition during which one or more alternatives to social media engagement are to be encouraged (e.g., through set receiving module 108 of the system 100 of FIG. 1). At step 204, the process 200 may include determining, via the social media network virtual assistant, the one or more alternatives to social media engagement that are to be encouraged (e.g., through alternative determination module 110 of the system 100 of FIG. 1). At step 206, the process 200 may include determining, via the social media network virtual assistant, that the at least one of the time and the condition have been satisfied (e.g., through time determination module 112 of the system 100 of FIG. 1). At step 208, the process 200 may include, responsive to determining that the at least one of the time and the condition has been satisfied, causing, via the social media network virtual assistant, the one or more alternatives to social media engagement to be communicated to the user (e.g., through alternative causing module 114 of the system 100 of FIG. 1).

According to an aspect, the first set of instructions may include a directive to implement a do-not-disturb functionality.

According to an aspect, the first set of instructions may include an override directed to one or more of the social media engagement activities that excepts the one or more of the social media engagement activities from the directive to implement the do-not-disturb functionality.

According to an aspect, the process 200 may include, responsive to determining that the at least one of the time and the condition has been satisfied, causing at least a portion of the social media engagement activities to be inoperable.

According to an aspect, the process 200 may include determining, via the social media network virtual assistant, that a social media connection of the user has a second set of instructions including at least one of a time and a condition during which at least one alternative to social media engagement is to be encouraged that overlaps with the at least one of the time and the condition included in the first set of instructions;

According to an aspect, causing, via the social media network virtual assistant, the one or more alternatives to social media engagement to be communicated to the user may include causing an alternative to social media engagement to be communicated to the user that involves the social media connection of the user.

According to an aspect, the process 200 may include determining, via the social media network virtual assistant, that the at least one of the time and the condition is no longer satisfied.

According to an aspect, the process 200 may include, responsive to determining that the at least one of the time and the condition are no longer satisfied, causing, via the social media network virtual assistant, cessation of communication of the one or more alternatives to social media engagement to the user.

According to an aspect, the process 200 may include, responsive to determining that the at least one of the time and the condition are no longer satisfied, causing a summary to be displayed, the summary including at least a portion of information missed during a time frame in which the one or more alternatives to social media engagement were encouraged.

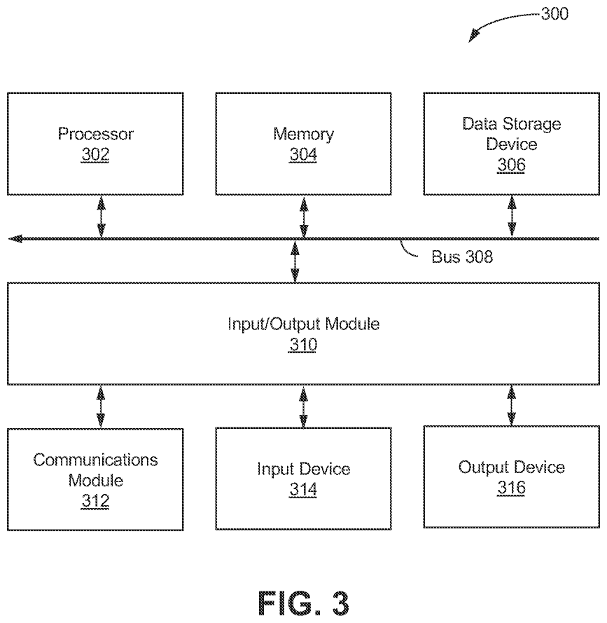

FIG. 3 is a block diagram illustrating an exemplary computing system 300 with which aspects of the subject technology can be implemented. In certain aspects, the computing system 300 may be implemented using hardware or a combination of software and hardware, either in a dedicated server, integrated into another entity, or distributed across multiple entities.

Computing system 300 (e.g., server and/or client) includes a bus 308 or other communication mechanism for communicating information, and a processor 302 coupled with bus 308 for processing information. By way of example, the computing system 300 may be implemented with one or more processors 302. Processor(s) 302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computing system 300 can include, in addition to hardware, code that creates an execution environment for the computer program in question, e.g., code that constitutes processor firmware, a protocol stack, a database management system, an operating system, or a combination of one or more of them stored in an included memory 304, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 308 for storing information and instructions to be executed by processor(s) 302. The processor(s) 302 and the memory 304 can be supplemented by, or incorporated in, special purpose logic circuitry.

The instructions may be stored in the memory 304 and implemented in one or more computer program products, i.e., one or more modules of computer program instructions encoded on a computer readable medium for execution by, or to control the operation of, the computing system 300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multi-paradigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 304 may also be used for storing temporary variable or other intermediate information during execution of instructions to be executed by processor(s) 302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computing system 300 further includes a data storage device 306 such as a magnetic disk or optical disk, coupled to bus 308 for storing information and instructions. Computing system 300 may be coupled via input/output module 310 to various devices. The input/output module 310 can be any input/output module. Exemplary input/output modules 310 include data ports such as USB ports. The input/output module 310 is configured to connect to a communications module 312. Exemplary communications modules 312 include networking interface cards, such as Ethernet cards and modems. In certain aspects, the input/output module 310 is configured to connect to a plurality of devices, such as an input device 314 and/or an output device 316. Exemplary input devices 314 include a keyboard and a pointing device, e.g., a mouse or a trackball, by which a user can provide input to the computing system 300. Other kinds of input devices 314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 316 include display devices such as an LCD (liquid crystal display) monitor, for displaying information to the user.

According to one aspect of the present disclosure, the above-described systems can be implemented using a computing system (e.g., computing system 300) in response to processor 302 executing one or more sequences of one or more instructions contained in memory 304. Such instructions may be read into memory 304 from another machine-readable medium, such as data storage device 306. Execution of the sequences of instructions contained in the main memory 304 causes processor(s) 302 to perform the process steps described herein. One or more processors in a multi-processing arrangement may also be employed to execute the sequences of instructions contained in memory 304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 300 can include clients and servers. A client and server are generally remote from each other and typically interact through a communication network. The relationship of client and server arises by virtue of computer programs running on the respective computers and having a client-server relationship to each other. Computing system 300 can be, for example, and without limitation, a desktop computer, laptop computer, or tablet computer. Computing system 300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor(s) 302 for execution. Such a medium may take many forms, including, but not limited to, non-volatile media, volatile media, and transmission media. Non-volatile media include, for example, optical or magnetic disks, such as data storage device 306. Volatile media include dynamic memory, such as memory 304. Transmission media include coaxial cables, copper wire, and fiber optics, including the wires that comprise bus 308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 300 reads game data and provides a game, information may be read from the game data and stored in a memory device, such as the memory 304. Additionally, data from the memory 304 servers accessed via a network the bus 308, or the data storage 306 may be read and loaded into the memory 304. Although data is described as being found in the memory 304, it will be understood that data does not have to be stored in the memory 304 and may be stored in other memory accessible to the processor 302 or distributed among several media, such as the data storage 306.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for using a social media network virtual assistant to encourage alternatives to social media engagement activities, the method comprising:
receiving, from a user, a first set of instructions regarding at least one of a time and a condition during which one or more alternatives to social media engagement are to be encouraged;
determining, via the social media network virtual assistant, the one or more alternatives to social media engagement that are to be encouraged;
determining, via the social media network virtual assistant, that the at least one of the time and the condition have been satisfied; and
responsive to determining that the at least one of the time and the condition has been satisfied, causing, via the social media network virtual assistant, the one or more alternatives to social media engagement to be communicated to the user.

2. The method of claim 1, wherein the first set of instructions includes a directive to implement a do-not-disturb functionality.

3. The method of claim 2, wherein the first set of instructions includes an override directed to one or more of the social media engagement activities that excepts the one or more of the social media engagement activities from the directive to implement the do-not-disturb functionality.

4. The method of claim 1, further comprising, responsive to determining that the at least one of the time and the condition has been satisfied, causing at least a portion of the social media engagement activities to be inoperable.

5. The method of claim 1, further comprising:
determining, via the social media network virtual assistant, that a social media connection of the user has a second set of instructions including at least one of a time and a condition during which at least one alternative to social media engagement is to be encouraged that overlaps with the at least one of the time and the condition included in the first set of instructions,
wherein causing, via the social media network virtual assistant, the one or more alternatives to social media engagement to be communicated to the user includes causing an alternative to social media engagement to be communicated to the user that involves the social media connection of the user.

6. The method of claim 1, further comprising:
determining, via the social media network virtual assistant, that the at least one of the time and the condition is no longer satisfied; and
responsive to determining that the at least one of the time and the condition are no longer satisfied, causing, via the social media network virtual assistant, cessation of communication of the one or more alternatives to social media engagement to the user.

7. The method of claim 5, further comprising, responsive to determining that the at least one of the time and the condition are no longer satisfied, causing a summary to be displayed, the summary including at least a portion of information missed during a time frame in which the one or more alternatives to social media engagement were encouraged.

8. A system configured for using a social media network virtual assistant to encourage alternatives to social media engagement activities, the system comprising:
one or more hardware processors configured by machine-readable instructions to:
receive, from a user, a first set of instructions regarding at least one of a time and a condition during which one or more alternatives to social media engagement are to be encouraged;
determine, via the social media network virtual assistant, the one or more alternatives to social media engagement that are to be encouraged;
determine, via the social media network virtual assistant, that the at least one of the time and the condition have been satisfied; and
responsive to determining that the at least one of the time and the condition has been satisfied, cause, via the social media network virtual assistant, the one or more alternatives to social media engagement to be communicated to the user.

9. The system of claim 8, wherein the first set of instructions includes a directive to implement a do-not-disturb functionality.

10. The system of claim 9, wherein the first set of instructions includes an override directed to one or more of the social media engagement activities that excepts the one or more of the social media engagement activities from the directive to implement the do-not-disturb functionality.

11. The system of claim 8, wherein the one or more hardware processors are further configured by machine-readable instructions to responsive to determining that the at least one of the time and the condition has been satisfied, cause at least a portion of the social media engagement activities to be inoperable.

12. The system of claim 8, wherein the one or more hardware processors are further configured by machine-readable instructions to:
determine, via the social media network virtual assistant, that a social media connection of the user has a second set of instructions including at least one of a time and a condition during which at least one alternative to social media engagement is to be encouraged that overlaps with the at least one of the time and the condition included in the first set of instructions;
wherein causing, via the social media network virtual assistant, the one or more alternatives to social media engagement to be communicated to the user includes causing an alternative to social media engagement to be communicated to the user that involves the social media connection of the user.

13. The system of claim 8, wherein the one or more hardware processors are further configured by machine-readable instructions to:
determine, via the social media network virtual assistant, that the at least one of the time and the condition is no longer satisfied;
responsive to determining that the at least one of the time and the condition are no longer satisfied, cause, via the social media network virtual assistant, cessation of communication of the one or more alternatives to social media engagement to the user.

14. The system of claim 12, wherein the one or more hardware processors are further configured by machine-readable instructions to responsive to determining that the at least one of the time and the condition are no longer satisfied, cause a summary to be displayed, the summary including at least a portion of information missed during a time frame in which the one or more alternatives to social media engagement were encouraged.

15. A non-transient computer-readable storage medium having instructions embodied thereon, the instructions being executable by one or more processors to perform a method for using a social media network virtual assistant to encourage alternatives to social media engagement activities, the method comprising:
receiving, from a user, a first set of instructions regarding at least one of a time and a condition during which one or more alternatives to social media engagement are to be encouraged;
determining, via the social media network virtual assistant, the one or more alternatives to social media engagement that are to be encouraged;
determining, via the social media network virtual assistant, that the at least one of the time and the condition have been satisfied; and
responsive to determining that the at least one of the time and the condition has been satisfied, causing, via the social media network virtual assistant, the one or more alternatives to social media engagement to be communicated to the user.

16. The computer-readable storage medium of claim 15, wherein the first set of instructions includes a directive to implement a do-not-disturb functionality.

17. The computer-readable storage medium of claim 16, wherein the first set of instructions includes an override directed to one or more of the social media engagement activities that excepts the one or more of the social media engagement activities from the directive to implement the do-not-disturb functionality.

18. The computer-readable storage medium of claim 15, wherein the method further comprises, responsive to determining that the at least one of the time and the condition has been satisfied, causing at least a portion of the social media engagement activities to be inoperable.

19. The computer-readable storage medium of claim 15, wherein the method further comprises:
determining, via the social media network virtual assistant, that a social media connection of the user has a second set of instructions including at least one of a time and a condition during which at least one alternative to social media engagement is to be encouraged that overlaps with the at least one of the time and the condition included in the first set of instructions;
wherein causing, via the social media network virtual assistant, the one or more alternatives to social media engagement to be communicated to the user includes causing an alternative to social media engagement to be communicated to the user that involves the social media connection of the user.

20. The computer-readable storage medium of claim 15, wherein the method further comprises:
determining, via the social media network virtual assistant, that the at least one of the time and the condition is no longer satisfied; and
responsive to determining that the at least one of the time and the condition are no longer satisfied, causing, via the social media network virtual assistant, cessation of communication of the one or more alternatives to social media engagement to the user.
